(19) United States
(12) Patent Application Publication
(10) Pub. No.: US 2016/0302090 A1
(43) Pub. Date: Oct. 13, 2016

(54) Backhaul Beam Searching

(71) Applicant: Telefonaktiebolaget LM Ericsson (publ), Stockholm (SE)

(72) Inventors: Stefan PARKVALL, Bromma (SE); Robert BALDEMAIR, Solna (SE); Sven PETERSSON, Sävedalen (SE); Henrik SAHLIN, Mölnlycke (SE)

(21) Appl. No.: 15/038,596

(22) PCT Filed: Dec. 4, 2013
(86) PCT No.: PCT/EP2013/075496

§ 371 Date: May 23, 2016

(51) Int. Cl. H04W 24/08; H04W 72/04; H04W 74/08; H04L 5/00; H04W 56/00

(52) U.S. Cl. CPC H04W 24/08; H04L 5/0007; H04W 56/001; H04W 74/0833; H04W 72/0446

(57) ABSTRACT

There is provided backhaul beam searching. A hub network node transmits a search signal that cycles in a predetermined time through all the transmit directions from a subgroup of all the possible transmit directions. The predetermined time is determined to allow a client network node to perform cell search measurements on each transmit direction of the hub network node for all receive directions of the client network node.

### TECHNICAL FIELD

Embodiments presented herein relate to backhaul beam searching, and particularly to methods, a hub network node, a client network node, computer programs, and a computer program product for backhaul beam searching.

### BACKGROUND

In communications networks, it may be challenging to obtain good performance and capacity for a given communications protocol, its parameters and the physical environment in which the communications network is deployed.

For example, increase in traffic within communications networks such as mobile broadband systems and an equally continuous increase in terms of the data rates requested by end-users accessing services provided by the communications networks may impact how cellular communications networks are deployed. One way of addressing this increase is to deploy lower-power network nodes, such as micro network nodes or pico network nodes, within the coverage area of a macro cell served by a macro network node. Examples where such additional network nodes may be deployed are scenarios where end-users are highly clustered. Examples where end-users may be highly clustered include, but are not limited to, around a square, in a shopping mall, or along a road in a rural area. Such a deployment of additional network nodes is referred to as a heterogeneous or multi-layered network deployment, where the underlaid layer of low-power micro or pico network nodes does not need to provide full-area coverage. Rather, low-power network nodes may be deployed to increase capacity and achievable data rates where needed. Outside of the micro- or pico-layer coverage, end-users would access the communications network by means of the overlaid macro cell.

One challenge with a large deployment of small micro or pico cells is providing backhaul connections from a micro or pico network node to the core network. Multiple solutions can be envisioned, including optical fibers and wireless backhaul solutions.

Traditionally, wireless backhaul operate at relatively high frequencies, in the order of 6-80 GHz or so, as spectrum in the lower frequency bands is scarce and preferably used for the access link between the user equipment of the end-users and network nodes serving as radio base stations for the user equipment. Operating at higher frequencies implies different propagation conditions than what is seen at the lower frequency bands where cellular access such as LTE (long term evolution telecommunications standard) typically operates. Due to propagation conditions at high frequencies, highly directive (i.e., narrow-beam) antennas are typically used. Often, wireless backhaul rely on line-of-sight propagation conditions, requiring an unobstructed path between the two points of the backhaul connection. However, in many cases the client network nodes are placed where there is no line-of-sight propagation to the hub network nodes.

One way is to provide non-line-of-sight (NLOS) backhaul using already standardized technology, such as LTE. As mentioned above, highly directive antennas are required at one or both of the client network node and the hub network node to obtain good received signal strength and a corresponding high data rate. Prior to communicating between the client network node and the hub network node, the direction of the antennas therefore needs to be adjusted. One example of such adjustment includes a manual, mechanical, adjustment of the antennas as performed by a technician. Furthermore, the antenna directions may occasionally need to be adjusted due to changes in the environment.

Abeam can be formed in many ways, e.g., using one (directional) antenna and mechanically controlling the direction of the antenna, and/or using a antenna array with multiple antenna elements. By setting the appropriate weights on each antenna element, either in baseband or at radio frequency (RF) level, a beam can be formed. It is envisioned that the hub network node is configured for handling one or more beams. Typically, the direction of each beam is fixed. Different possibilities with respect to the RF circuitry for the beams exist. Some of these will be summarized next.

According to a first example, the same (or larger) number of RF chains (power amplifiers, filters, etc.) than the number of beams is used. This implies that transmission activity in one beam is independent from the activity in other beams.

According to a second example, a smaller number of RF chains than the number of beams is used. As an example, eight different beam directions may be supported but at most four of these may be used at the same time. One benefit with such a setup is the reduced number of RF components. However, this setup also implies a dependency between the transmission activity in different beams; simultaneous transmission may only occur in a subset of beams where the maximum number of simultaneously active beams is given by the number of RF chains.

According to a third example. a large number of RF chains, typically in the same order as the number of antenna elements, is used such that the direction of the beam(s) can be adjusted in baseband. This results in an infinite number of beam direction possibilities. However, for cell search, a limited number of beam alternatives are typically used at the hub network node, and only those may thus be evaluated.

At the client network node side, a narrow beam can be formed either electronically or mechanically. In either case, both manual and automatic adjustment of the direction is possible.

Hence, there is still a need for an improved backhaul beam searching.

### SUMMARY

An object of embodiments herein is to provide improved backhaul beam searching.

According to a first aspect there is presented a method for backhaul beam searching. The method is performed by a hub network node. The hub network node is arranged to transmit in a set of transmit directions. The method comprises performing beam searching during a predetermined time. The method comprises, alternately, determining a current transmit direction of the beam searching according to a predetermined pattern. The predetermined pattern cycles through all transmit directions from a subgroup of transmit directions from the set of transmit directions. The method comprises, alternately, transmitting a cell search signal in the current transmit direction. The predetermined time is determined to allow a client network node to perform cell search measurements on each transmit direction of the hub network node for all receive directions of the client network node.

Advantageously this provides improved backhaul beam searching.

According to a second aspect there is presented a hub network node for backhaul beam searching. The hub network node is arranged to transmit in a set of transmit directions. The hub network node comprises a processing unit. The processing unit is arranged to perform beam searching during a predetermined time. The processing unit is arranged to, alternately, determine a current transmit direction of the beam searching according to a predetermined pattern. The predetermined pattern cycles through all transmit directions from a subgroup of transmit directions from the set of transmit directions. The processing unit is arranged to, alternately, transmit a cell search signal in the current transmit direction. The predetermined time is determined to allow a client network node to perform cell search measurements on each transmit direction of the hub network node for all receive directions of the client network node.

According to a third aspect there is presented a computer program for backhaul beam searching, the computer program comprising computer program code which, when run on a hub network node, causes the hub network node to perform a method according to the first aspect.

According to a fourth aspect there is presented a method for backhaul beam searching. The method is performed by a client network node. The client network node is arranged to receive in a set of receive directions. The method comprises performing beam searching during a predetermined time. The method comprises, alternately, adjusting the receive direction of the cell search measurements to a current receive direction according to a predetermined pattern. The method comprises, alternately, performing cell search measurements in the current receive direction for a cell search signal transmitted by a hub network node. The predetermined time is determined to allow the client network node to perform the cell search measurements on each transmit direction of the hub network node for all receive directions of the client network node.

According to a fifth aspect there is presented a client network node for backhaul beam searching. The client network node is arranged to receive in a set of receive directions. The client network node comprises a processing unit. The processing unit is arranged to perform beam searching during a predetermined time. The processing unit is arranged to, alternately, adjust the receive direction of the cell search measurements to a current receive direction according to a predetermined pattern. The processing unit is arranged to, alternately, perform cell search measurements in the current receive direction for a cell search signal transmitted by a hub network node. The predetermined time is determined to allow the client network node to perform the cell search measurements on each transmit direction of the hub network node for all receive directions of the client network node.

According to a sixth aspect there is presented a computer program for backhaul beam searching, the computer program comprising computer program code which, when run on a client network node, causes the client network node to perform a method according to the fourth aspect.

According to a seventh aspect there is presented a method, a hub network node, and a computer program, for providing parameters for backhaul beam searching. A method comprises a hub network node to transmit a cell search signal, wherein the cell search signal comprises primary synchronization signals, PSS, and secondary synchronization signals, SSS. The method further comprises the hub network node to embed a physical layer cell identity in at least one of a PSS and an SSS using a pre-determined association between PSS, SSS, and physical layer cell identities, where the physical layer cell identity is associated with beam search procedure parameters.

Advantageously this enables a flexible (since not preconfigured) and cost effective way to provision parameters required for beam searching at the client network node.

According to an eight aspect there is presented a method, a client network node, and a computer program, for providing parameters for backhaul beam searching. A method comprises a client network node to receive a cell search signal comprising primary synchronization signals, PSS, and secondary synchronization signals, SSS. The PSS and SSS determine a physical layer cell identity by using a pre-determined association between PSS, SSS, and physical layer cell identities. The method further comprises the client network node to derive beam search procedure parameters from the physical layer cell identity by using a pre-determined association between the physical layer cell identity and the beam search procedure parameters.

According to a ninth aspect there is presented a computer program product comprising a computer program according to at least one of the third aspect, the sixth aspect, the seventh aspect, and the ninth aspect, and a computer readable means on which the computer program is stored.

It is to be noted that any feature of the first, second, third, fourth, fifth, sixth, seventh, eight and ninth aspects may be applied to any other aspect, wherever appropriate. Likewise, any advantage of the first aspect may equally apply to the second, third, fourth, fifth, sixth, seventh, eight and/or ninth aspect, respectively, and vice versa. Other objectives, features and advantages of the enclosed embodiments will be apparent from the following detailed disclosure, from the attached dependent claims as well as from the drawings. Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communications network according to embodiments;

FIG. 2a is a schematic diagram showing functional modules of a hub network node according to an embodiment;

FIG. 2b is a schematic diagram showing functional units of a hub network node according to an embodiment;

FIG. 2c is a schematic diagram showing hardware units of a hub network node according to an embodiment;

FIG. 3a is a schematic diagram showing functional modules of a client network node according to an embodiment;

FIG. 3b is a schematic diagram showing functional units of a client network node according to an embodiment;

FIG. 4 shows one example of a computer program product comprising computer readable means according to an embodiment;

FIGS. 5a and 5b schematically illustrate beam search procedures according to embodiments; and

FIGS. 6, 7, 8, and 9 are flowcharts of methods according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

Hereinafter a network node to be backhauled is denoted a “client network node” and a network node providing backhauls is denoted a “hub network node”. The client network node thus establishes a backhaul connection to the core network via the hub network node. In case of a wireless backhaul, the term client network node thus denotes the unit (or subunit within a micro or pico network node) that connects the micro or pico network node to the hub network node. The hub network node denotes the other end (with respect to the client network node) of the wireless backhaul link where the wireless backhaul continues over a wired connection to the core network. The hub network node may be co-located with a macro network node. Thus, the backhauled data may or may not be transported through a macro node.

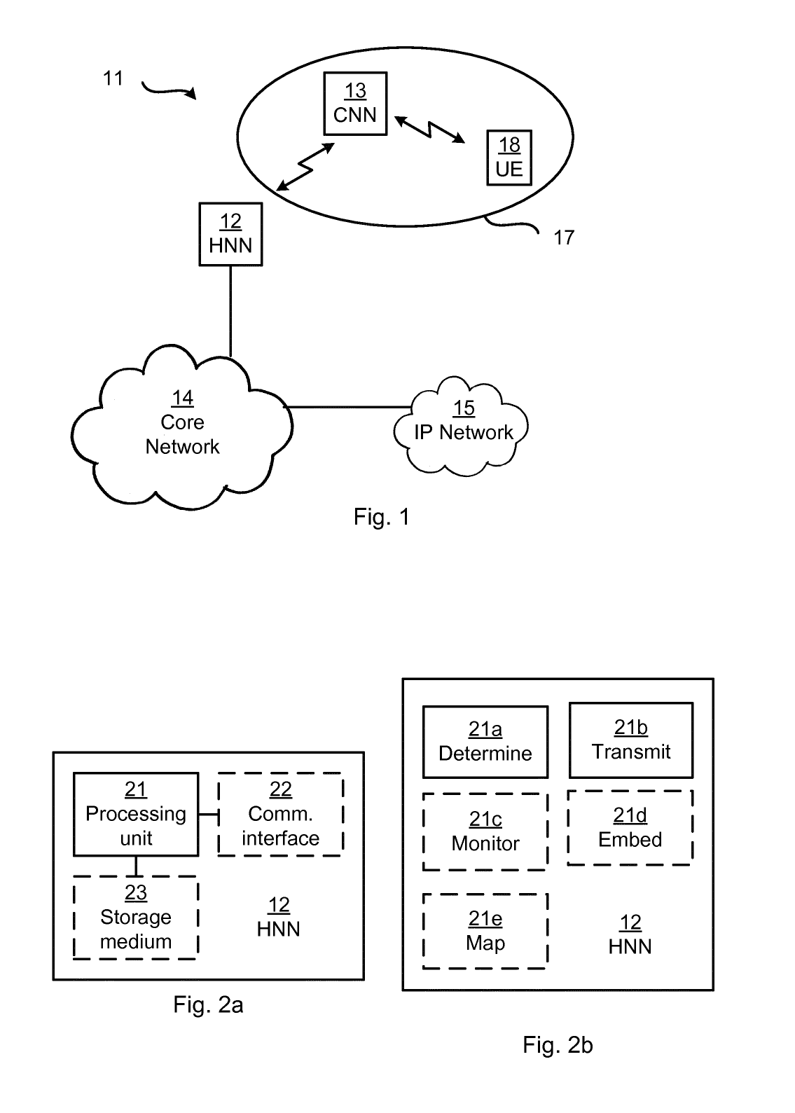

FIG. 1 is a schematic diagram illustrating a communications network 11 where embodiments presented herein can be applied. The communications network 11 comprises a cell 17 served by a client network node (CNN) 13. The client network node 13 is wirelessly backhauled by a hub network node 12. The hub network node 12 is operatively connected to a core network 14 which in turn is operatively connected to a service providing Internet Protocol based network 15. A user equipment (UE) 18 located in the cell 17 and served by the CNN 13 is thereby able to access services and data provided by the IP network 15. The hub network node is arranged to transmit in a set of transmit directions. The client network node is arranged to receive in a set of receive directions. It may be that a current transmit direction of the hub network node does not correspond to a current receive direction of the client network node. Beam searching may be used in order to align the receive direction and the transmit direction. Situations in which beam searching needs to be performed by at least one client network node in order to be backhauled by a hub network node may thus occur. Embodiments disclosed herein relate to perform such beam searching. The embodiments disclosed herein thus relate to backhaul beam searching for selecting between several beam directions in both a hub network node and a client network node by performing measurements at the client network node.

The embodiments disclosed herein relate to backhaul beam searching. In order to obtain backhaul beam searching there is provided a hub network node, a method performed by the hub network node, a computer program comprising code, for example in the form of a computer program product, that when run on a hub network node, causes the hub network node to perform the method. In order to obtain backhaul beam searching there is further provided a client network node, a method performed by the client network node, a computer program comprising code, for example in the form of a computer program product, that when run on a client network node, causes the client network node to perform the method.

FIG. 2a schematically illustrates, in terms of a number of functional modules, the components of a hub network node 12 according to an embodiment. A processing unit 21 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 41a (as in FIG. 4), e.g. in the form of a storage medium 23. Thus the processing unit 21 is thereby arranged to execute methods as herein disclosed. The storage medium 23 may also comprise persistent storage, which, for example, can be any single one or combination of magnetic memory, optical memory, solid state memory or even remotely mounted memory. The hub network node 12 further comprises a communications interface 22 for communications with at least one client network node 13, with at least one UE 18, and for communications with the core network 14. As such the communications interface 22 may comprise one or more ports, transmitters and receivers, comprising analogue and digital components and a suitable number of antennae for radio communications with at least one client network node 13 and at least one UE 18 and for wired communications with the core network 14. The processing unit 21 controls the general operation of the hub network node 12 e.g. by sending data and control signals to the communications interface 22 and the storage medium 23, by receiving data and reports from the communications interface 22, and by retrieving data and instructions from the storage medium 23. Other components, as well as the related functionality, of the hub network node 12 are omitted in order not to obscure the concepts presented herein.

FIG. 2b schematically illustrates, in terms of a number of functional units, the components of a hub network node 12 according to an embodiment. The hub network node 12 of FIG. 2b comprises a number of functional units; a determine unit 21a, and a transmit unit 21b. The hub network node 12 of FIG. 2b may further comprises a number of optional functional units, such as any of a monitor unit 21c, an embed unit 21d, and a map unit 21e. The functionality of each functional unit 21a-e will be further disclosed below in the context of which the functional units may be used. For example, herein disclosed steps of determining may be performed by executing the functionality of the determining unit 21a, herein disclosed steps of transmitting may be performed by executing the functionality of the transmit unit 21b, herein disclosed steps of monitoring may be performed by executing the functionality of the monitor unit 21c, herein disclosed steps of embedding may be performed by executing the functionality of the embed unit 21d, and herein disclosed steps of mapping may be performed by executing the functionality of the map unit 21e. In general terms, each functional unit 21a-e may be implemented in hardware or in software. The processing unit 21 may thus be arranged to from the storage medium 23 fetch instructions as provided by a functional unit 21a-e and to execute these instructions, thereby performing any steps as will be disclosed hereinafter.

FIG. 2c schematically illustrates some units of a hub network node 12a, b according to an embodiment. The hub network node 12 of FIG. 2c comprises pooled baseband resources 25a. The pooled baseband resources 25a comprise multiple baseband chains 25b. In some implementations baseband resources can be moved between baseband chains whereas in other implementations this is not possible. The baseband chain 25b implements the functionality prior to mixing the baseband signal to radio frequency (or intermediate frequency). The baseband chain 25b for example performs digital signal processing, digital-to-analogue conversion, and filtering.

Each baseband chain 25b is operatively connected to a radio chain 25c. Each radio chain 25c comprises a modulator arranged to mix the output signal from the baseband chains 25b to radio frequency, filter it, and amplify it.

The output signals from the radio chains 25c are provided to a switch network 12d. The switch network 12d is arranged to switch the output signal of the power amplifier at the radio chains 25c to the correct beam forming network, thus generating the desired beams.

A radio frequency beam forming network 25e is arranged to generate the beams. In the radio frequency beam forming network 25e an incoming signal may be split into multiple signals and an individual phase shift (and potentially an amplitude tapering) may be applied to each signal prior feeding it into the individual antenna elements. In case of a fixed grid of beams 24 a set of predefined phase shifts is available for each beam than can be selected to generate the desired beam.

At reference numeral 24 the resulting beam directions are shown. In this example, eight different beam directions are supported but at most four of these can be used at the same time.

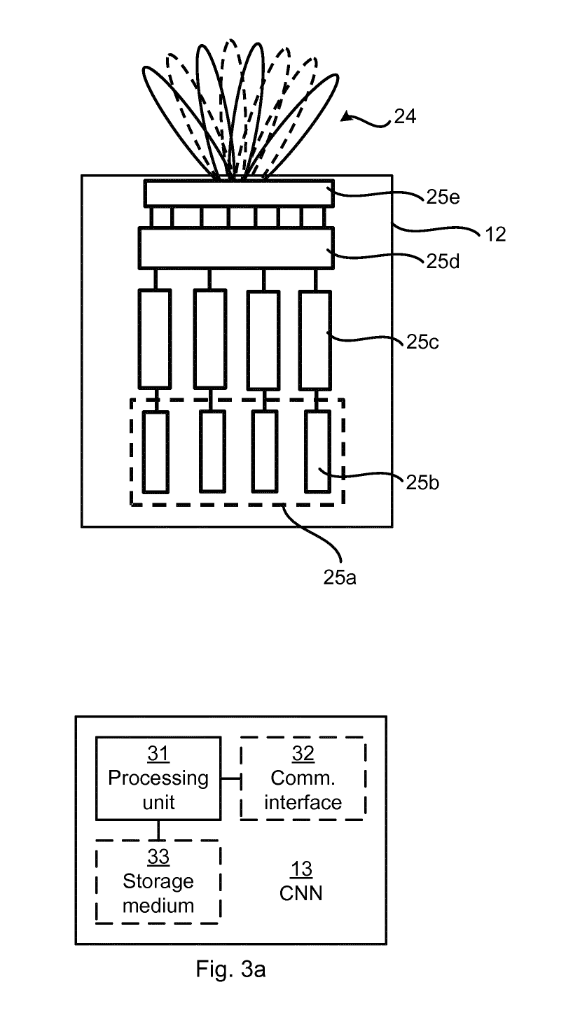

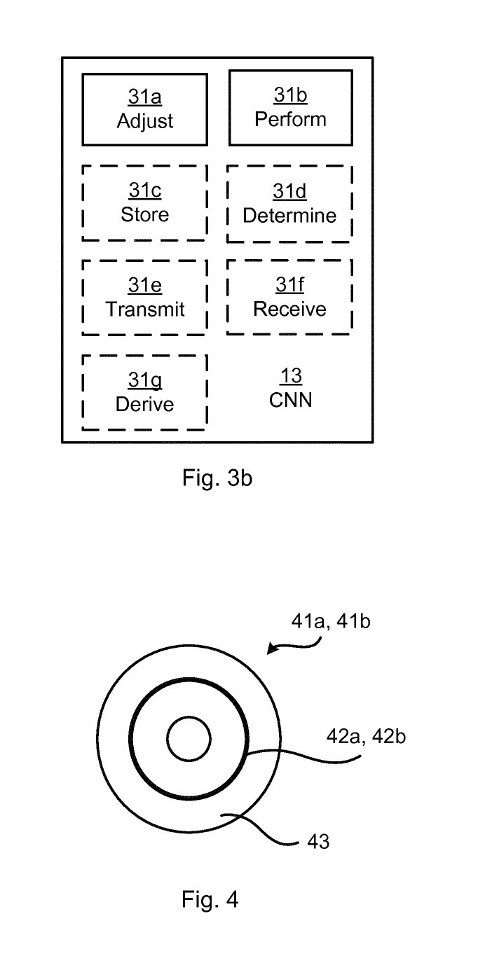

FIG. 3a schematically illustrates, in terms of a number of functional modules, the components of a client network node 13 according to an embodiment. A processing unit 31 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 41b (as in FIG. 4), e.g. in the form of a storage medium 33. Thus the processing unit 31 is thereby arranged to execute methods as herein disclosed. The a storage medium 33 may also comprise persistent storage, which, for example, can be any single one or combination of magnetic memory, optical memory, solid state memory or even remotely mounted memory. The client network node 13 further comprises a communications interface 32 for communications with a hub network node 12 and at least one UE 18. As such the communications interface 32 may comprise one or more ports, transmitters and receivers, comprising analogue and digital components and a suitable number of antennae for radio communications with a hub network node 12 and at least one UE 18. The processing unit 31 controls the general operation of the client network node 13 e.g. by sending data and control signals to the communications interface 32 and the storage medium 33, by receiving data and reports from the communications interface 32, and by retrieving data and instructions from the storage medium 33. Other components, as well as the related functionality, of the client network node 13 are omitted in order not to obscure the concepts presented herein.

FIG. 3b schematically illustrates, in terms of a number of functional units, the components of a client network node 13 according to an embodiment. The client network node 13 of FIG. 3b comprises a number of functional units; an adjust unit 31a, and a perform unit 31b. The client network node 13 of FIG. 3b may further comprises a number of optional functional units, such as any of a store unit 31c, a determine unit 31d, a transmit unit 31e, a receive unit 31f, and a derive unit 31g. The functionality of each functional unit 31a-g will be further disclosed below in the context of which the functional units may be used. For example, herein disclosed steps of adjusting may be performed by executing the functionality of the adjust unit 31a, herein disclosed steps of performing may be performed by executing the functionality of the perform unit 31b, herein disclosed steps of storing may be performed by executing the functionality of the store unit 31c, herein disclosed steps of determining may be performed by executing the functionality of the determine unit 31d, herein disclosed steps of transmitting may be performed by executing the functionality of the transmit unit 31e, herein disclosed steps of receiving may be performed by executing the functionality of the receive unit 31f, and herein disclosed steps of deriving may be performed by executing the functionality of the derive unit 31g. In general terms, each functional unit 31a-g may be implemented in hardware or in software. The processing unit 31 may thus be arranged to from the storage medium 33 fetch instructions as provided by a functional unit 31a-g and to execute these instructions, thereby performing any steps as will be disclosed hereinafter.

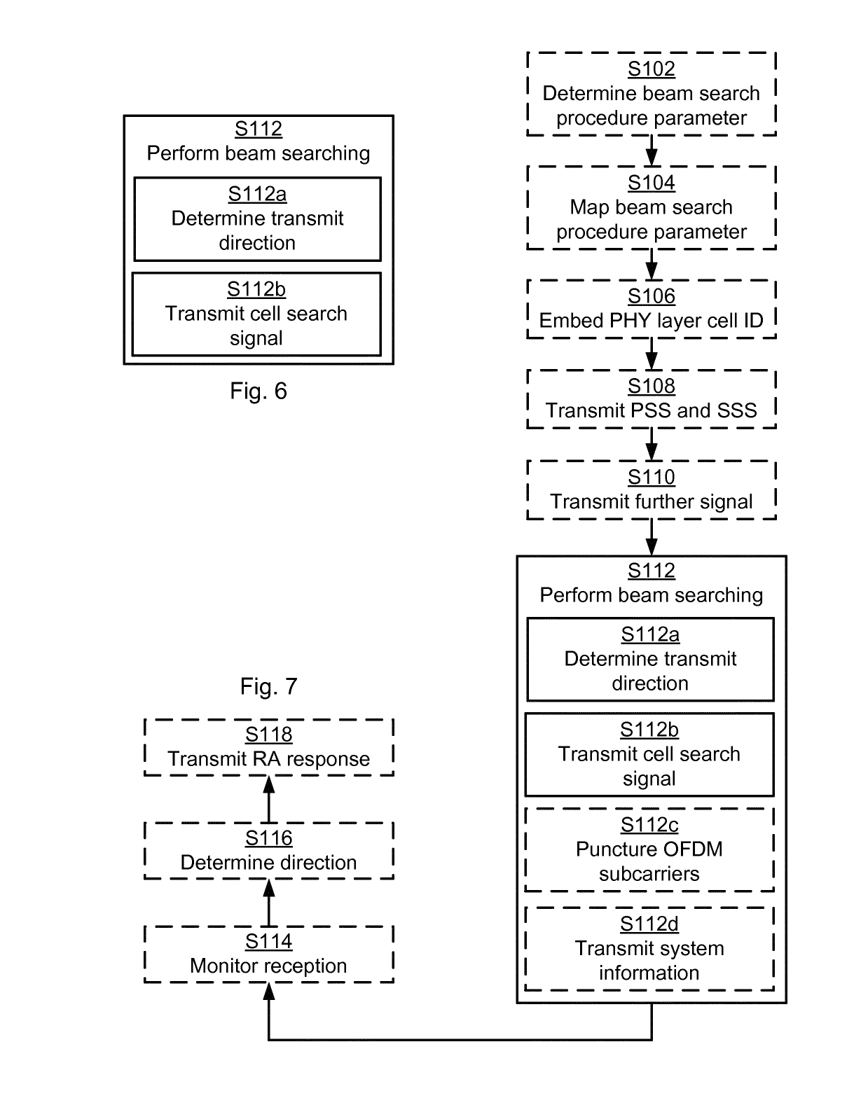

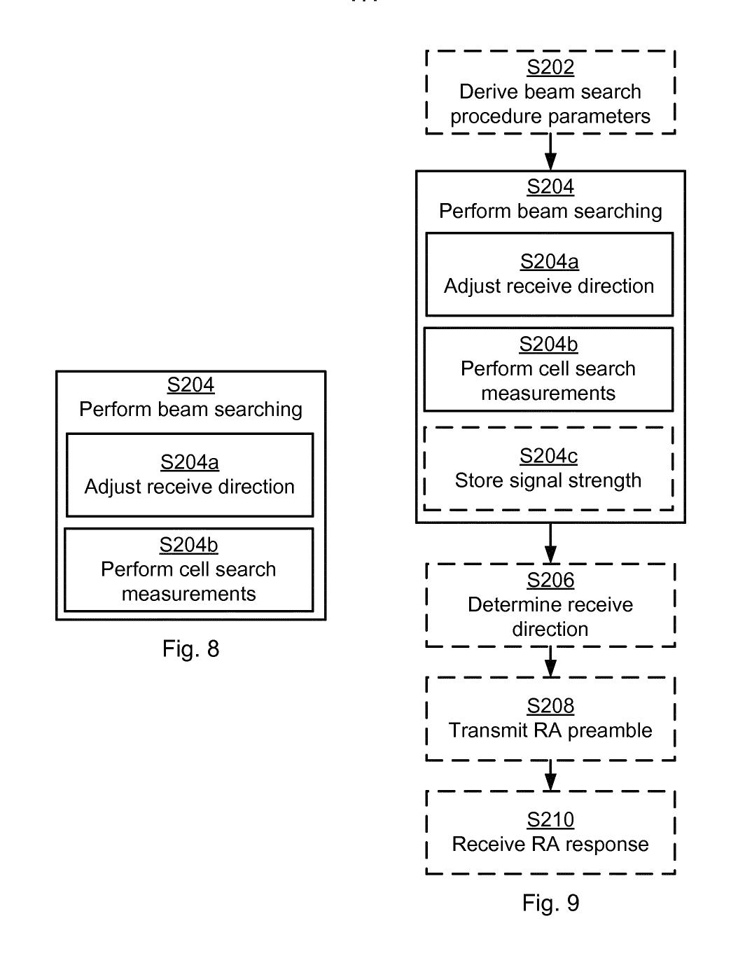

FIGS. 6 and 7 are flow chart illustrating embodiments of methods for backhaul beam searching. The methods of FIGS. 6 and 7 are performed by the hub network node 12. FIGS. 8 and 9 are flow chart illustrating embodiments of methods for backhaul beam searching. The methods of FIGS. 8 and 9 are performed by the client network node 13. The methods are advantageously provided as computer programs 42a, 42b. FIG. 4 shows one example of a computer program product 41a, 41b comprising computer readable means 43. On this computer readable means 43, at least one computer program 42a, can be stored, which computer program 42a can cause the processing unit 21 and thereto operatively coupled entities and devices, such as the communications interface 22 and the storage medium 23 to execute methods according to embodiments described herein. On this computer readable means 43, at least one computer program 42b, can be stored, which computer program 42b can cause the processing unit 31 and thereto operatively coupled entities and devices, such as the communications interface 32 and the storage medium 33 to execute methods according to embodiments described herein. The computer programs 42a, 42b and/or computer program product 41a, 41b may thus provide means for performing any steps as herein disclosed.

In the example of FIG. 4, the computer program product 41a, 41b is illustrated as an optical disc, such as a CD (compact disc) or a DVD (digital versatile disc) or a Blu-Ray disc. The computer program product 41a, 41b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory. Thus, while the computer programs 42a, 42b are here schematically shown as a track on the depicted optical disk, the computer programs 42a, 42b can be stored in any way which is suitable for the computer program product 41a, 41b.

Some embodiments are based on enabling the client network node, for each possible antenna direction, perform a cell search and measure (and store in a memory) the received signal strength from the set of candidate beams transmitted by the hub network node and detected by the client network node. After scanning all possible directions, the client network node may adjust its antenna to the direction of the strongest received signal and perform a random access following LTE principles. The disclosed process does not require one RF chain per beam but even works with a smaller number of RF chains than the number of possible beams. This is enabled by sharing the RF chains between the beams in the time domain. In general terms, it may be assumed that the hub network node is arranged to transmit in one or more fixed beams and that the client network node has one adjustable narrow receive beam.

Reference is now made to FIG. 6 illustrating a method for backhaul beam searching according to an embodiment. The method is performed by the hub network node. The hub network node is arranged to transmit in a set of transmit directions. The hub network node is arranged to, in a step S112, perform beam searching during a predetermined time. The beam searching comprises two sub-steps S112a and S112b which are alternately repeated. The hub network node is arranged to, in a step S112a, determine a current transmit direction of the beam searching according to a predetermined pattern. The predetermined pattern cycles through all transmit directions from a subgroup of transmit directions from the set of transmit directions. The subgroup may include all elements in the group of transmit directions. Alternatively, it may be a proper subgroup with less elements than all elements in the group of transmit directions. Examples of predetermined patterns will be disclosed below. The hub network node is arranged to, in a step S112b, transmit a cell search signal in the current transmit direction. Hence, alternately a transmit direction is determined (denote the current transmit direction), and alternately a cell search signal is transmitted in the current direction. After the cell search signal has been transmitted in the current direction a new direction determined and a cell search signal is transmitted in the new direction, and so on. This procedure is repeated for all directions from a subgroup of transmit directions from the set of transmit directions according to the predetermined pattern and during a predetermined time. The predetermined time is determined to allow a client network node 13 to perform cell search measurements on each transmit direction of the hub network node for all receive directions of the client network node. The predetermined time may thus be regarded as the total time during which the hub network node and client network node scan through all possible transmit and receive directions, respectively.

Reference is now made to FIG. 8 illustrating a method for backhaul beam searching according to an embodiment. The method is performed by the hub network node. The client network node is arranged to receive in a set of receive directions. The client network node is arranged to, in a step S204, perform beam searching during a predetermined time by. The beam searching comprises two sub-steps S204a and S204b which are alternately repeated. The client network node is arranged to, in a step S204a adjust the receive direction of the cell search measurements to a current receive direction according to a predetermined pattern. The predetermined pattern of the client network node is associated with the predetermined pattern of the hub network node. Examples of predetermined patterns will be disclosed below. The client network node is arranged to, in a step S204b, perform cell search measurements in the current receive direction for a cell search signal transmitted by the hub network node 12. The cell search signal may by the hub network node 12 be transmitted according to steps S112, S112a, and S112b above. The predetermined time is determined to allow the client network node to perform the cell search measurements on each transmit direction of the hub network node for all receive directions of the client network node.

Reference is now made to FIG. 7 illustrating methods for backhaul beam searching as performed by the hub network node according to further embodiments.

There may be different ways for the hub network node to transmit the cell search signal. According to one embodiment the cell search signal comprises primary synchronization signals, PSS, and secondary synchronization signals, SSS. Further, each transmit direction may be associated with a unique combination of PSS and SSS. For example, there may be several beams with the same PSS but different SSS. System information, such as any of a master information block (MIB) and a system information block (SIB) may be transmitted in the same intervals as the PSS and/or SSS. Thus, according to an embodiment the hub network node is arranged to, in a step S112d, transmit system information together with the PSS and SSS per transmit direction interval. One PSS/SSS may be transmitted in each beam direction before the beam direction is switched. That is, according to an embodiment only one PSS and only one SSS is transmitted in each transmit direction during one transmit direction interval before the transmit direction is switched to another transmit direction.

There may be different ways to determine the time spent in each direction. For example, the time in each direction may correspond to duration of a radio frame. Thus, according to an embodiment transmission time in each transmit direction per transmit direction interval corresponds to duration of a radio frame. For example, the time in each direction may correspond to transmission of two OFDM symbols. Thus, according to an embodiment transmission time in each transmit direction per transmit direction interval corresponds to transmission of two orthogonal frequency-division multiplexing, OFDM, symbols.

The hub network node may monitor for random access attempts made by the client network node at least in a predetermined random access resource occurring after each cycle. Hence, according to an embodiment the hub network node is arranged to, in a step S114, monitor reception of a random access (RA) attempt made by the client network node at least during a predetermined random access resource interval. The hub network node may be further arranged to, in a step S116, determine a direction of the client network node based on at least one of a time of arrival of the random access attempt and content of the random access attempt. The client network node may thus report the direction in which the cell search signal was heard, i.e. the direction from the hub network node to the client network node. Another way of the hub network node obtaining the direction is for the hub network node listen for random access attempts in all beam directions and detect in which beam direction the hub network node received the client network node response (alternatively without considering the content in the response).

If a RA attempt detected the hub network node may transmit RA response. Hence, according to an embodiment the hub network node is arranged to, in a step S118, transmit, after having detected the RA attempt, a RA response to the client network node. The RA response may be transmitted in direction determined in step S116.

One overall embodiment for backhaul beam searching as performed by the hub network node will now be disclosed.

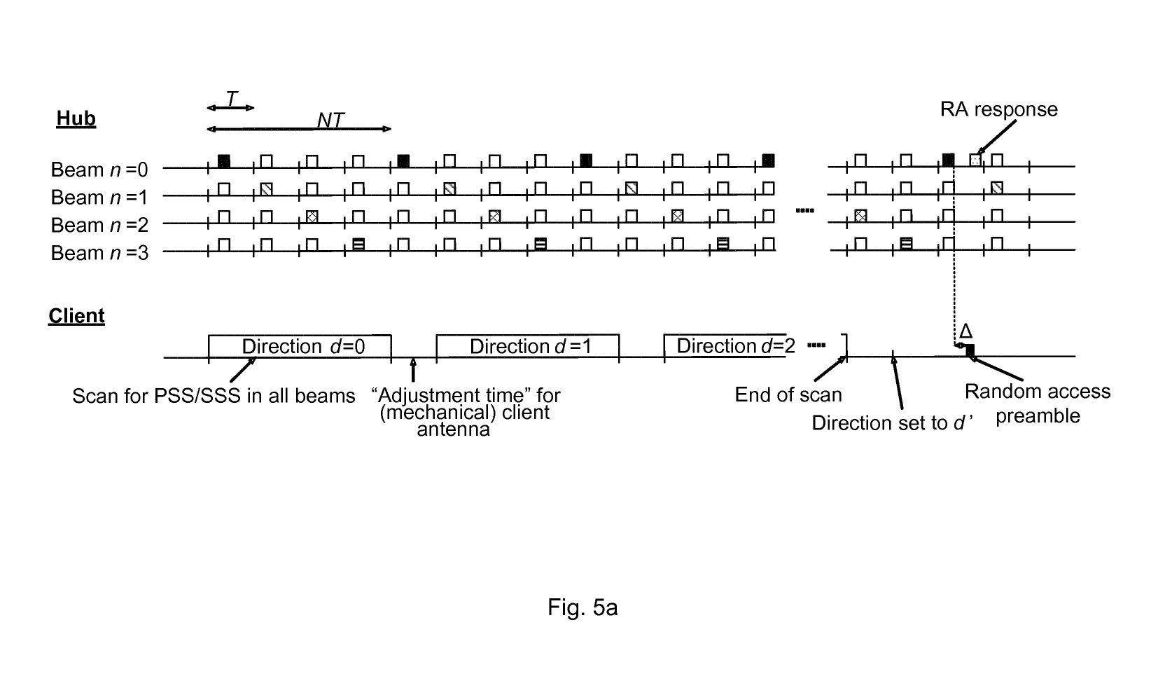

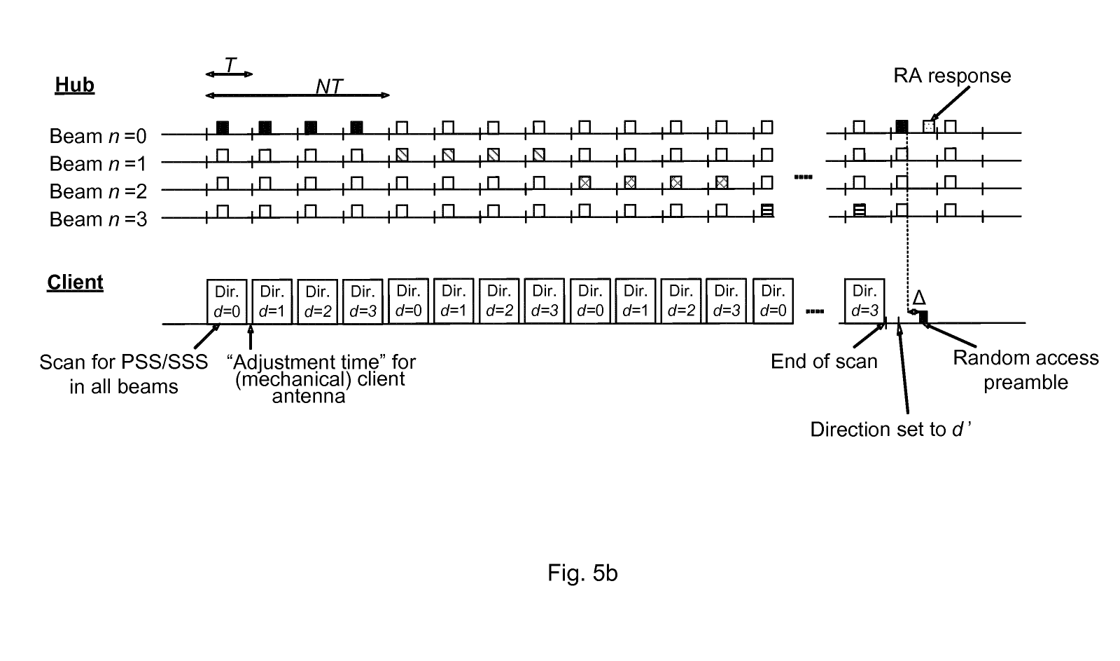

Step S301: The hub network node transmits PSS and SSS in beam n (cell n) at least at fixed time intervals, each interval starting at nT+iNT, i=0, 1, and ending before (n+1)T+iNT. Each beam may have a different PSS/SSS, i.e., each beam may represent a separate cell in an LTE context. This is illustrated in FIG. 5a.

T denotes the observation time required in a client network node for sufficiently reliable detection of the PSS/SSS. According to one example is to set T equal to 10 ms, i.e. one radio frame, but other (and possibly longer) observation times can also be used. According to one example the beam switching time T equals two OFDM symbols. This implies that PSS and SSS are transmitted for one beam n during two consecutive OFDM symbols and possibly for another beam, say beam n+1, within the two next OFDM symbols. The time difference between two consecutive PSS sequences from the same beam is 5 ms which corresponds to 14·5=70 OFDM symbols. Thus, by changing beam at the rate of every second OFDM symbol, at most 35 beams may be supported. The PSS and SSS detectors may use arbitrary observation time (i.e. arbitrary number of frames) for detection, within this overall embodiment. In order to reduce inter-beam interference, the sub-carriers corresponding to the PSS and SSS allocations may have to be punctured for all downlink transmissions in all beams during setup.

N denotes the number of beams in a beam group at the hub network node. n denotes the beam number, or direction (cell number in case of different PSS/SSS) within the hub network node. The beams within the hub network node are numbered 0, 1, . . . , N−1.

The client network node may thus assume that there is a PSS/SSS corresponding to beam/cell n at least at the time intervals [nT+iNT, (n+1)T+iNT[. However, PSS/SSS may also be present at other time intervals. One example is the situation with one RF chain per possible beam in which case PSS/SSS will be available in all beams all the time. Another example is a situation where some of the beams already are used to serve other client network nodes. In the latter case those beams may transmit PSS/SSS using the same RF chain. The unused beams may in this latter case share one (or in the general case a few) RF chains between the candidate beams in the time domain.

Alternatively the hub network node transmits PSS and SSS in beam n (cell n) at least at time instances iT+nNT, i=0, 1, . . . . That is, PSS/SSS is consecutively transmitted several times into the same beam n before switching to transmission in the next beam n+1. This is illustrated in FIG. 5b.

Step S302: The hub network node transmits information necessary for the client network nodes to access the communications network (e.g. relevant parts of MIB and SIBs) in the same intervals as PSS and SSS. This information may at least contain detailed parameters related to RA transmission. Alternatively, the RA parameters are fixed and hardcoded in the client network nodes.

Step S303: The hub network node monitors for RA attempts for beam n at least in one predefined RA resource occurring after the PSS/SSS transmission. A predefined timing relation may be used to determine when the hub network node monitors for RA responses for beam n. The predefined timing relation may be a fixed time Δ, where Δ denotes the time from transmission of PSS/SSS to (reception of) a RA resource for beam/cell n, but other possibilities also exist, e.g. a time window starting at/centered around Δ, see FIG. 5a, and FIG. 5b. The shape of the antenna used to receive the RA attempts may be the same as the shape of the beam used for PSS/SSS transmission.

Even if different beams transmit the same PSS/SSS the hub network node knows which transmitted beam the client network node was listening to due to the predefined timing relation Δ between transmission by the hub network node and RA response reception by the hub network node. If a RA attempt in a beam is detected, the hub network node transmits a RA response to the client network node, for example according to the LTE specifications.

The procedure of the above disclosed overall embodiment has been outlined under the assumption that the hub network node cannot simultaneously transmit PSS/SSS in all beams. One reason for this could be that the hub network node is not equipped with sufficiently many radio units. However, nothing prevents the hub network node to transmit PSS/SSS in a beam/cell more often than what is stated in step S301 above.

Reference is now made to FIG. 9 illustrating methods for backhaul beam searching as performed by the client network node according to further embodiments.

As noted above, the cell search signal may comprise PSS/SSS. Thus, the step S204b of performing cell search measurements comprises detecting primary synchronization signals, PSS, and secondary synchronization signals, SSS, transmitted by the hub network node.

There may be different ways for the client network node to determine which direction the cell search signal was transmitted, and thus which direction to determine as its selected receive direction.

For example, during the cell search the client network node may store values for each direction. Hence, according to an embodiment the client network node is arranged to, in a step S204c store, for each one of the receive directions, signal strength information of the cell search measurements.

For example, the client network node may select the strongest value and the direction related thereto. Hence, according to an embodiment the client network node is arranged to, in a step S206, determine, corresponding to a strongest of the stored signal strength information, a selected receive direction.

The hub network node may then be directed in the selected direction and transmit a RA preamble to the hub network node. Hence, according to an embodiment the client network node is arranged to, in a step S208, transmit a RA preamble in the selected receive direction to the hub network node.

There may be different alternatives for when the client network node is to transmit the RA preamble. For example, the random access preamble may be transmitted in a predetermined time instant selected according to the selected receive direction. For example, the client network node may wait for a preamble response from the hub network node. Hence, according to an embodiment the client network node is arranged to, in a step S210 receive, after having transmitted the random access preamble, a random access response from the hub network node in the selected receive direction.

One overall embodiment for backhaul beam searching as performed by the client network node will now be disclosed.

Step S401: The client network node initializes the direction of the receive antenna, d, to 0 (corresponding to a first client receive direction).

Step S402: The client network node adjusts the client antenna to direction d.

Step S403: The client network node, during a period of length NT, performs cell search (i.e. PSS and SSS detection) to find possible candidate beams/cells as transmitted by the hub network node.

For each cell found in the cell search procedure during the period of length NT, the client network node measures the signal strength (e.g. using the Reference Signal Received Power (RSRP) measurement in LTE).

The client network node stores the physical-layer cell identity (or the time when the cell was detected) and the corresponding RSRP value for each detected cell together with the direction d in a list. Optionally, only RSRP values above a predefined threshold trigger storing of the cell identity and RSRP value in the list. This can be useful to avoid attempting to connect to weak cells in steps S405-8.

In each period T of the overall observation period NT, the client network node may find one or multiple candidate cells depending on how many beams that are simultaneously transmitting PSS/SSS.

Step S404: The client network node steps the receive antenna direction d to the next value.

Steps S402-4 are repeated until all receive directions have been evaluated. This process can be repeated several times if no good candidate beams are found.

Step S405: The client network node finds the strongest RSRP value stored in the list from the scan phase (as in step SX03). The client network node sets d′ to the corresponding receive antenna direction and n′ to the corresponding physical-layer cell identity or time when the cell was detected.

The client network node directs the receive antenna in the selected direction d′.

Step S406: The client network node ensures that the client network node has access to the information necessary for accessing the hub network node, e.g., by receiving (parts of) relevant MIB/SIBs. This information may be configured by the hub network node, hardcoded in the client network node or obtained by other means.

Step S407: The client network node waits until PSS/SSS corresponding to cell or time n′ is received (the PSS and SSS do not have to be detected again).

Step S408: The client network node transmits a RA preamble in a RA resource occurring a predefined time after PSS/SSS occurrence in step S406 (for example a time Δ after the PSS/SSS).

The random access channel (RACH) preamble is given by the cell ID obtained from the PSS/SSS. Given the fixed timing relation between PSS/SSS occurrence and RA transmission, the preamble ID is not necessarily derived from the cell ID. In principle any (e.g. random) preamble may be used. However, to save complexity there could be linkage between cell ID and preamble ID or even a fixed preamble ID could be used.

Step S409: The client network node waits for a RA response according to common LTE behavior.

For the alternative where the hub network node transmits PSS and SSS in beam n (cell n) at least at time instances iT+nNT, i=0, 1, . . . (as in FIG. 5b), instead of receiving for a time period NT from the same direction, the direction steps every period T. After the client network node has stepped through all directions it starts with the first direction again; i.e., at time i the client network node listens to direction d=iT mod L where L is the number of receive directions.

The client network node may continue the cell search procedure, even after a connection has been established with the hub network node, in order to find better candidate cells.

The client network node may need to obtain parameters prior to the beam search procedure For example, the number of beams, N, or at least the product NT may be required. Such parameters may either be preconfigured, provided over a separate channel (e.g. through a cellular network by equipping the client network node and the hub network node with cellular modems, or estimated. In general terms, a too large value of NT is not detrimental but results in a longer search time.

The client network node may also need parameters related to the RA procedure. According to LTE, this information is provided as part of the system information (in some of the SIBs). The same approach may be used for the backhaul case (at the cost of broadcasting the MIB and SIBs). In case RF chains are shared across beams, the MIB/SIB transmission timing needs to be staggered such that MIB/SIB transmissions in different beams do not overlap in time. Alternatively, the necessary information may be provided through the cellular network as discussed above, or be part of a modified MIB structure by reusing currently unused bits in the MIB.

The amount of SIBs broadcasted may be minimized, instead relying on dedicated signaling of system information (as client network nodes do not move and new client network nodes seldom are introduced in a beam, thereby avoiding frequent broadcast of system information).

Common to the above, some parameters need to be known at the client network node side. In the first variant N and/or NT must to be known, i.e., the number of beams the cell search signal is transmitted into or the duration of such a sweep. For the second variant the number L and T, i.e. how often a cell search signal is transmitted into the same direction and its duration need to be known.

Beam search procedure parameters such as N, NT, L, T may either be preconfigured or provided over a separate channel (e.g. through the cellular network by equipping at least the client network node with a cellular modem). However, the first alternative may be regarded as inflexible and the second alternative may be regarded as costly. Herein is disclosed to encode beam search procedure parameters (e.g., N, NT, L, T, or a combination thereof) in the physical layer cell identity.

The hub network node may transmit a cell search signal (as disclosed above in step S112b), where the cell search signal comprises PSS and SSS. According to an embodiment the hub network node is arranged to, in a step S106, embed a physical layer cell identity in at least one of a PSS and an SSS using a pre-determined association between PSS, SSS, and physical layer cell identities. The physical layer cell identity is associated with beam search procedure parameters.

Several cell identities may be associated with one value. Thus, according to an embodiment a plurality of physical layer cell identities is associated with one value of a beam search procedure parameter. Further, several cell identities may be associated with two parameters. Thus, according to an embodiment a plurality of physical layer cell identities are associated with one value of a first beam search procedure parameter and one value of a second beam search procedure parameter.

According to an embodiment the hub network node is arranged to, in a step S102, determine at least one beam search procedure parameter to be used during the beam searching. The beam search procedure parameter may be determined by a mapping to the physical layer cell identity. Hence, according to an embodiment the hub network node is arranged to, in a step S104, map the determined at least one beam search procedure parameter to the physical layer cell identity according to a predetermined mapping; and, in a step S108, transmit PSS and SSS in which the physical layer cell identity has been embedded. The beam search procedure parameter may be dependent on a time difference between the PSS and the SSS. The beam search procedure parameter may be dependent on a carrier frequency of the transmitted PSS and SSS.

Also further signals, such as a third synchronization signal (TSS) may be transmitted by the hub network node. Hence, according to an embodiment the hub network node is arranged to, in a step S110, transmit a further signal after transmitting the PSS and the SSS. The beam search procedure parameter may then be based on the further signal.

According to an embodiment the physical layer cell identity is embedded as a physical layer cell identity group parameter. The PSS may indicate the group and the SSS may indicate the ID within that group.

The client network node may thus be enabled to from the cell search signal derive the beam search procedure parameters. According to an embodiment the client network node is arranged to, in a step S202 derive beam search procedure parameters from the physical layer cell identity by using a pre-determined association between the physical layer cell identity and the beam search procedure parameters. Once the client network node has detected a candidate cell identity, it may determine the parameter values (e.g., N, NT, L, T) and use these in the subsequent beam search process.

This enables a client network node to detect beam search parameters encoded into the cell search signal. However, finding the cell search signal may be regarded as involving beam searching (during beam searching the client network node tries to find the cell search signal in different directions). To enable the client network node to find any cell search signal it thus has to assume very conservative value for N or NT (i.e. very long) in a first method (FIG. 6a) or perform a large number of cycles in a second method (FIG. 6b). Once the client network node knows N or NT it can set the correct values and thus speed up the beam searching process.

Two overall embodiments relating to how beam search procedure parameters may be embedded in the cell search signal will now be disclosed.

In the first overall embodiment physical-layer cell identities N_{ID}^{cell} are grouped and each group corresponds to a specific value of a parameter. The parameter could for example be N, NT, L, or T, see Table 1.

TABLE 1
Physical-layer cell identities are grouped and each group
corresponds to a specific value of a parameter.

| Physical-layer cell identity | |
|---|---|
| (N_{ID}^{cell}) | Value of Parameter |
| IDₐ, ID_{b}, ID_{c} , . . . | Val₁ |
| ID_{d}, IDₑ, ID_{f}, . . . | Val₂ |
| ID_{g}, IDₕ, IDᵢ | Val₃ |

In Table 1 IDₐ, ID_{b}, etc. are physical layer cell identities and could for example correspond to physical-layer cell identities 0, 1, etc. Other mappings are also possible. Also the group size equal to three is just an example. Val₁, Val₂, etc. are the values of the parameter.

According to an extension, each group assigns values to multiple parameters (Parameter 1, Parameter 2, etc.), see Table 2.

TABLE 2
Physical-layer cell identities are grouped. Each group assigns
values to multiple parameters.

| Physical-layer | Value of | Value of |
|---|---|---|
| cell identity (N_{ID}^{cell}) | Parameter 1 | Parameter 2 |
| IDₐ, ID_{b}, ID_{c}, . . . | Val_{1,1} | Val_{2,1} |
| ID_{d}, IDₑ, ID_{f}, . . . | Val_{1,2} | Val_{2,2} |
| ID_{g}, IDₕ, IDᵢ | Val_{1,3} | Val_{2,3} |

Val₁, and Val₂, are the values assigned to Parameter 1 and Parameter 2, respectively.

One grouping is to reuse the already existing grouping into physical-layer cell identity groups (168 in total) and cell identities within a group (3 in total). According to an embodiment the physical-layer cell identity group N_{ID}⁽¹⁾ is derived from SSS and the physical-layer identity within the physical-layer cell-identity group N_{ID}⁽²⁾ is given by PSS. One mapping involves, for example, that each N_{ID}⁽²⁾ is mapped to a parameter value. This would enable up to three different parameter values. Alternatively, each N_{ID}⁽¹⁾ may be mapped to a parameter value. Since it may be unlikely that 168 different parameter values are needed, a grouping of N_{ID}⁽¹⁾ could be applied. In this case the mapping corresponds to the mappings as outlined in Table 1 and Table 2 with the difference that the first column would be N_{ID}⁽¹⁾ (and not physical-layer cell identity N_{ID}^{cell}).

In the second overall embodiment the mapping of physical-layer cell identities to parameters is algorithmic instead of table-based. For example, all physical layer cell identities that results in the same value when applied to a mapping function ƒ( ) are part of the same group and thus assigned the same value to a parameter, for example as follows:

ƒ(N_{ID}^{cell})=k→P₁=Valₖ

where N_{ID}^{cell} is the physical-layer cell identity, P₁ the parameter a value should be assigned to (e.g. N, NT, L, or T) and Valₖ is the assigned value. It is also possible to assign values to multiple parameters:

ƒ(N_{ID}^{cell})=k→P₁=Val_{1,k},P₂=Val_{2,k}

where P₁ and P₂ are the first and second parameter, respectively, and Val_{1,k} and Val_{2,k} are the assigned values if the function delivers the value k.

In the following, two example functions ƒ( ) are provided. As a first example, consider the function mod(N_{ID}^{cell},K)=k. Every K:th physical-layer cell identity N_{ID}^{cell} is in the same group. K denotes the number of groups. As a second example, consider the function └N_{ID}^{cell}/K┘=k. K consecutive physical-layer cell identities are in the same group. K denotes the number of groups.

The determination of the parameter values from the physical-layer cell identities may additionally take the carrier frequency into account. Depending on the carrier frequency (or frequency band) upon which cell search currently is performed, different sets of tables or functions may be used. Equivalently, the function ƒ above could take the carrier frequency ƒ_{c} as an argument:

ƒ(N_{ID}^{cell},ƒ_{c})=k→P₁=Val_{1,k},P₂=Val_{2,k}

The duplex scheme used, FDD or TDD, may additionally or alternatively be taken into account when determining the parameters. The duplex scheme used could be determined from the relative location of PSS and SSS which differs between FDD and TDD in LTE.

Additionally or alternatively a third synchronization signal (TSS) may be used as input to the function ƒ (or selection of the tables). The TSS may have a fixed time relation to the PSS/SSS.

Additionally or alternatively, the timing between PSS and TSS may be used as input to the function ƒ (or selection of the tables). Here, a few timing candidates then have to be evaluated in the client network node. The timing between PSS and SSS may also be used in the same manner.

Instead of using the physical-layer cell identity N_{ID}^{cell} as input to the function ƒ( ) also the physical-layer cell-identity group N_{ID}⁽¹⁾ or physical-layer identity within the physical-layer cell-identity group N_{ID}⁽²⁾ may be used.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-31. (canceled)

32. A method for backhaul beam searching, the method being performed by a hub network node, wherein the hub network node is arranged to transmit in a set of transmit directions, the method comprising:
performing beam searching during a predetermined time by, alternately:
determining a current transmit direction of the beam searching according to a predetermined pattern, the predetermined pattern cycling through all transmit directions from a subgroup of transmit directions from the set of transmit directions; and
transmitting a cell search signal in the current transmit direction;
wherein the predetermined time is determined to allow a client network node to perform cell search measurements on each transmit direction of the hub network node for all receive directions of the client network node.

33. The method of claim 32, wherein the cell search signal comprises primary synchronization signals (PSS) and secondary synchronization signals (SSS).

34. The method of claim 33, wherein each transmit direction is associated with a unique combination of PSS and SSS.

35. The method of claim 33, wherein the transmitting comprises transmitting system information together with the PSS and SSS per transmit direction interval.

36. The method of claim 32, wherein transmission time in each transmit direction per transmit direction interval corresponds to duration of a radio frame.

37. The method of claim 32, wherein transmission time in each transmit direction per transmit direction interval corresponds to transmission of two orthogonal frequency-division multiplexing (OFDM) symbols.

38. The method of claim 32, further comprising monitoring reception of a random access attempt made by the client network node at least during a predetermined random access resource interval.

39. The method of claim 38, further comprising determining a direction of the client network node based on at least one of a time of arrival of the random access attempt and content of the random access attempt.

40. The method of claim 38, further comprising transmitting, after having detected the random access attempt, a random access response to the client network node.

41. The method of claim 33, wherein only one PSS and only one SSS is transmitted in each transmit direction during one transmit direction interval before the transmit direction is switched to another transmit direction.

42. The method of claim 32, wherein the cell search signal comprises primary synchronization signals (PSS) and secondary synchronization signals (SSS), the method further comprising:
embedding a physical layer cell identity in at least one of a PSS and an SSS using a pre-determined association between PSS, SSS, and physical layer cell identities, the physical layer cell identity being associated with beam search procedure parameters.

43. The method of claim 42, further comprising:
determining at least one beam search procedure parameter to be used during the beam searching;
mapping the determined at least one beam search procedure parameter to the physical layer cell identity according to a predetermined mapping; and
transmitting PSS and SSS in which the physical layer cell identity has been embedded.

44. The method of claim 42:
further comprising transmitting a third synchronization signal (TSS) after transmitting the PSS and the SSS;
wherein the beam search procedure parameter is based on the TSS.

45. The method of claim 44, wherein the beam search procedure parameter is dependent on a time difference between the PSS and the TSS.

46. The method of claim 42, wherein the physical layer cell identity is embedded as a physical layer cell identity group parameter.

47. The method of claim 42, wherein the beam search procedure parameter is dependent on a carrier frequency of the transmitted PSS and SSS.

48. The method of claim 42, wherein a plurality of physical layer cell identities are associated with one value of a beam search procedure parameter.

49. The method of claim 42, wherein a plurality of physical layer cell identities are associated with one value of a first beam search procedure parameter and one value of a second beam search procedure parameter.

50. A method for backhaul beam searching, the method being performed by a client network node, wherein the client network node is configured to receive in a set of receive directions, the method comprising:
performing beam searching during a predetermined time by, alternately:
adjusting a receive direction of cell search measurements to a current receive direction according to a predetermined pattern; and
performing cell search measurements in the current receive direction for a cell search signal transmitted by a hub network node; and
wherein the predetermined time is determined to allow the client network node to perform the cell search measurements on each transmit direction of the hub network node for all receive directions of the client network node.

51. The method of claim 50, wherein the step of performing cell search measurements comprises detecting primary synchronization signals (PSS) and secondary synchronization signals (SSS) transmitted by the hub network node.

52. The method of claim 50, further comprising storing, for each one of the receive directions, signal strength information of the cell search measurements.

53. The method of claim 52, further comprising determining, corresponding to a strongest of the stored signal strength information, a selected receive direction.

54. The method of claim 53, further comprising transmitting a random access preamble in the selected receive direction to the hub network node.

55. The method of claim 54, wherein the random access preamble is transmitted in a predetermined time instant selected according to the selected receive direction.

56. The method of claim 54, further comprising receiving, after having transmitted the random access preamble, a random access response from the hub network node in the selected receive direction.

57. The method of claim 50, wherein the cell search signal comprises primary synchronization signals (PSS) and secondary synchronization signals (SSS) determining a physical layer cell identity using a pre-determined association between PSS (SSS) and physical layer cell identities, the method further comprising:
deriving beam search procedure parameters from the physical layer cell identity by using a pre-determined association between the physical layer cell identity and the beam search procedure parameters.

58. A hub network node for backhaul beam searching, wherein the hub network node is configured to transmit in a set of transmit directions, the hub network node comprising:
a processor:
memory containing instructions executable by the processor whereby the hub network node is operative to:
perform beam searching during a predetermined time by, alternately:
determine a current transmit direction of the beam searching according to a predetermined pattern, the predetermined pattern cycling through all transmit directions from a subgroup of transmit directions from the set of transmit directions; and
transmit a cell search signal in the current transmit direction;
wherein the predetermined time is determined to allow a client network node to perform cell search measurements on each transmit direction of the hub network node for all receive directions of the client network node.

59. A client network node for backhaul beam searching, wherein the client network node is configured to receive in a set of receive directions, the client network node comprising:
a processor:
memory containing instructions executable by the processor whereby the client network node is operative to perform beam searching during a predetermined time by, alternately:
adjust the receive direction of the cell search measurements to a current receive direction according to a predetermined pattern; and
perform cell search measurements in the current receive direction for a cell search signal transmitted by a hub network node;
wherein the predetermined time is determined to allow the client network node to perform the cell search measurements on each transmit direction of the hub network node for all receive directions of the client network node.

60. A computer program product stored in a non-transitory computer readable medium for backhaul beam searching, the computer program product comprising software instructions which, when run on a processor of a hub network node configured to transmit in a set of transmit directions, causes the hub network node to:
perform beam searching during a predetermined time by, alternately:
determine a current transmit direction of the beam searching according to a predetermined pattern, the predetermined pattern cycling through all transmit directions from a subgroup of transmit directions from the set of transmit directions; and
transmit a cell search signal in the current transmit direction;
wherein the predetermined time is determined to allow a client network node to perform cell search measurements on each transmit direction of the hub network node for all receive directions of the client network node.

61. A computer program product stored in a non-transitory computer readable medium for backhaul beam searching, the computer program product comprising software instructions which, when run on a processor of a client network node configured to receive in a set of receive directions, causes the client network node to:
perform beam searching during a predetermined time by, alternately:
adjust a receive direction of cell search measurements to a current receive direction according to a predetermined pattern; and
perform cell search measurements in the current receive direction for a cell search signal transmitted by a hub network node; and
wherein the predetermined time is determined to allow the client network node to perform the cell search measurements on each transmit direction of the hub network node for all receive directions of the client network node.
